(19) United States
(12) Patent Application Publication
(10) Pub. No.: US 2002/0038283 A1
(43) Pub. Date: Mar. 28, 2002

(54) Electronic bid method and electronic bid system

(76) Inventor: Tsuyoshi Tokoro, Fuchu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/996,562

(22) Filed: Nov. 30, 2001

Related U.S. Application Data
(63) Continuation of application No. PCT/JP00/06572, filed on Sep. 25, 2000.

(30) Foreign Application Priority Data
Aug. 2, 2000 (JP) 2000-234507

(51) Int. Cl. G06F 17/60

(52) U.S. Cl. 705/37

(57) ABSTRACT

A buyer notifies a service provider of desired merchandize/services by inputting information from a Web or sending mail. The service provider notifies each seller of the category of the purchase request merchandize and the number of potential buyers desiring this merchandise. A seller presents information such as a price to the buyer via the service provider.

### CROSS REFERENCE TO RELATED APPLICATIONS

This is a Continuation Application of PCT Application No. PCT/JP00/06572, filed Sep. 25, 2000, which was not published under PCT Article 21(2) in English.

This application is based upon and claims the benefit of priority from the prior Japanese Patent Application No. 2000-234507, filed Aug. 2, 2000, the entire contents of which are incorporated herein by reference.

### BACKGROUND OF THE INVENTION

1. Field of the Invention

The present invention relates to an electronic bid scheme (merchandise providing information notification scheme) and, more particularly, to a scheme for allowing a seller to sell an item to a buyer upon collecting data representing buyers' purchase consensuses in a system for selling and buying merchandise/services using a network.

2. Description of the Related Art

In a system for selling and buying merchandise using a network, a method of making a buyer search for and select a seller on a Web results in a waste of time and communication cost in finding out a seller who offers desired merchandise at low cost. It is almost impossible to select an optimal seller among enormous information of a network. In addition, in a so-called reverse auction scheme in which a seller accepts or declines a buyer's bid, the seller must make a decision for the request of each individual user, resulting in an overload on the seller side.

As described above, in the conventional scheme, a buyer wastes time and communication cost before he or she can find out a seller who offers buyer's desired merchandize at low cost. In the reverse auction scheme, an overload was imposed on the seller side because the seller must make a decision for the request of each individual user.

### BRIEF SUMMARY OF THE INVENTION

The present invention has been made in consideration of the conventional problems described above, and has as its object to provide an electronic bid method and electronic bid system capable of allowing a buyer to select a seller offering the best condition by allowing the seller to sell an item to the buyer upon collecting data representing buyers' purchase consensuses in a system for selling and purchasing merchandise/services using a network.

In order to achieve the above object, according to the present invention, there is provided an electronic bid method characterized in that a buyer registers desired merchandise/service information in a database of a service provider via a network, the service provider discloses to a seller via the network information including the number of potential buyers for each merchandise/service on the basis of the registered merchandise/service information, the seller determines a sales condition on the basis of the disclosed information and notifies the service provider of merchandise providing information, and the service provider notifies the potential buyers of the merchandise providing information notified from the seller.

An electronic bid system according to the present invention is an electronic bid system for allowing a service provider to serve as an agent in a sales transaction between a buyer and a seller via a network, characterized by comprising purchase merchandise/service information processing means comprised of means for storing merchandise/service information to be purchased by a buyer and means for notifying a seller of the number of potential buyers for each merchandise/service on the basis of the merchandise/service information to be purchased and stored in the storing means, and sales merchandise/service information processing means comprised of means for notifying the service provider of a sales condition determined by the seller and means for notifying the buyer of the sales condition notified from the seller.

According to the present invention, in the system for selling and purchasing merchandise/services using the network, the seller collects the data representing the buyers' purchase consensuses and sells merchandise based on the consensuses. A buyer notifies a service provider serving as an agent for sales/purchase information of buyer's desired merchandise/service by mail or an input from a Web. The service provider registers the buyer's desired merchandise/service in a database. Of all the registered data, the category of the buyer's desired merchandise and the number of potential buyers for this merchandise are disclosed from the service provider to the seller. The seller browses the disclosed data and provides information such as a price to the buyer by electronic mail or on the Web via the service provider. This does not overload the seller and makes it possible for a buyer to select a seller offering the best condition. That is, the seller makes a bid for a buyer's request, and the buyer can know the best seller. This system can eliminate cumbersome operation of the seller's bids for individual buyers. Once the buyers' requests are stored in the database, only macro data of the merchandise category and the number of potential users (quantity of merchandise) are disclosed. This allows the seller to make bids for some quantity. Since only the macro data are disclosed to the seller, leakage of personal information of users can be prevented. The database display for each seller can be customized to display only necessary merchandize categories. When the seller sends merchandize providing information, the number of users of the database to be displayed is reset to prevent the same information from being repeatedly sent.

According to the present invention, once the buyers' requests are stored in the database of the service provider, only macro data, i.e., the merchandise category and the number of potential users (quantity of merchandise) are disclosed. This allows the seller to make bids for some quantity. The seller need not make a bit for each individual buyer, resulting in convenience.

### BRIEF DESCRIPTION OF THE SEVERAL VIEWS OF THE DRAWING

An embodiment of the present invention will be described with reference to the following accompanying drawings, in which

FIG. 1 is a block diagram of a system to which an electronic bid method of the present invention is applied;

FIG. 2 is a flow chart showing processing of the electronic bid method according to the present invention;

FIG. 3 is a view showing the data format of desired request information of buyers registered in the database of a service provider in the system shown in FIG. 1;

FIG. 4 is a view showing a table in which information representing the number of buyers is stored in relation to information representing sellers who deal purchase request merchandise items for each purchase request merchandise item; and

FIG. 5 is a conceptual view showing the data flow between the user, service provider, and seller in the system shown in FIG. 1.

### DETAILED DESCRIPTION OF THE INVENTION

The present invention will be described in detail by way of its illustrated embodiment.

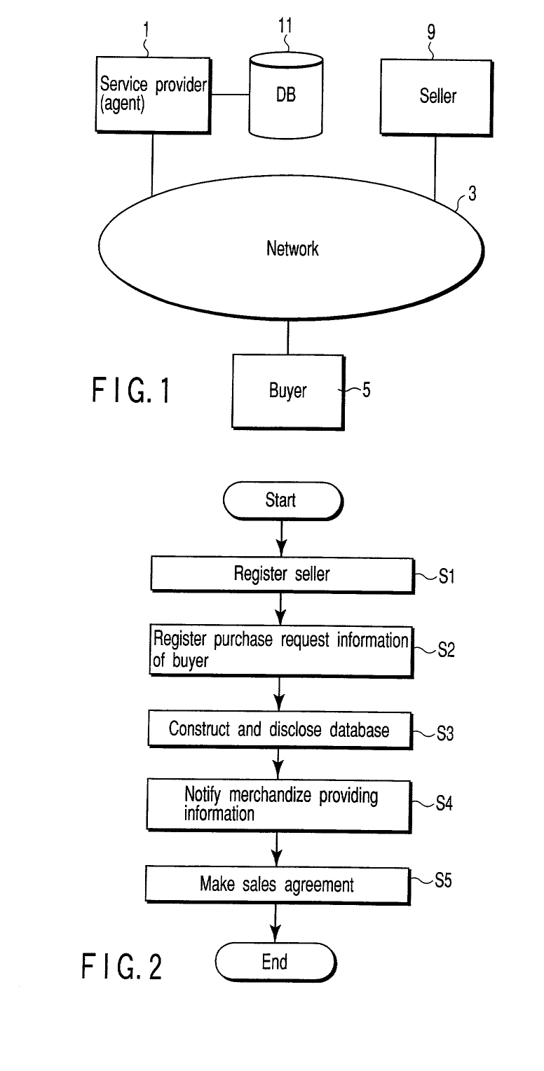

FIG. 1 is a block diagram showing a system to which an electronic bid scheme of the present invention is applied. Referring to FIG. 1, a service provider 1 functioning as an agent is connected to a buyer's terminal 5 via a network 3 and to a seller's terminal 9. The service provider 1 has a database 11 in which purchase request merchandize/service information transmitted from a buyer is registered.

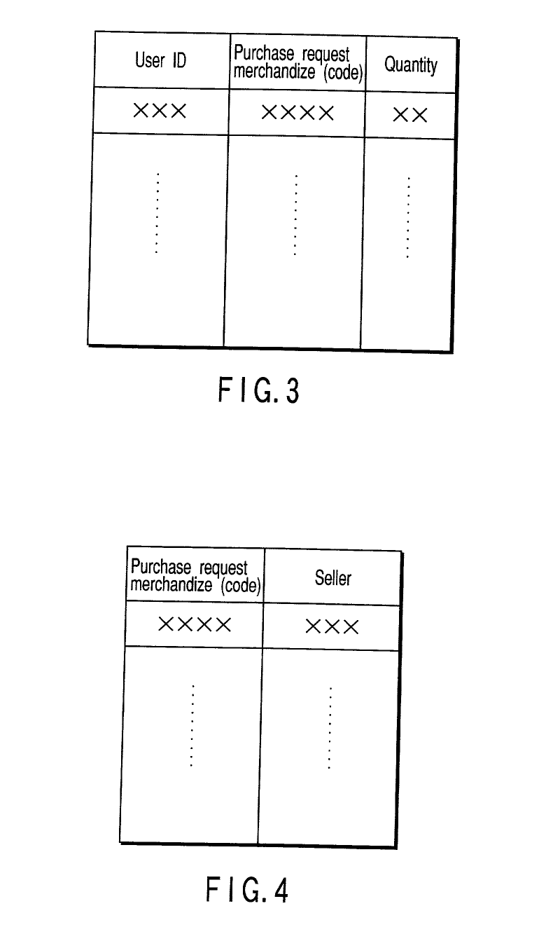

FIG. 2 is a flow chart showing processing of an electronic bid scheme according to the present invention. FIG. 3 is a conceptual view showing the flow of data exchanged between a buyer, seller, and service provider.

In step S1 of FIG. 2, each seller is registered. That is, a seller who wants to sell merchandize/services makes agreement with the service provider and registers himself or herself. In this case, the category of merchandize/services is registered.

FIG. 3 shows the format of buyer's purchase request information registered in the database of the service provider. As shown in FIG. 3, the format has a user ID field for specifying a buyer, a purchase request merchandize (code information) field, and a quantity field. FIG. 4 is a table which stores a list of sellers for each merchandize item. The service provider calculates the quantity for each merchandize item from the table shown in FIG. 3, refers to the list shown in FIG. 4, and notifies the seller of the purchase request quantity for each merchandise item.

Browse

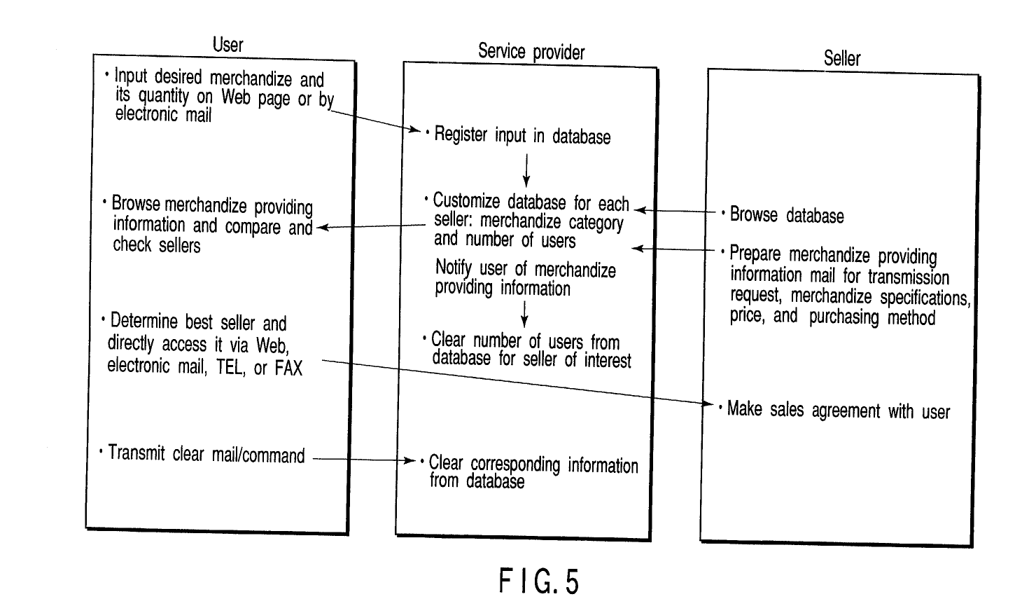

In step S3 of FIG. 2, buyer's purchase request information is registered. More specifically, as shown in FIG. 5, each user accesses the predetermined Web page of the service provider and registers purchase request merchandize/service information. This information may be registered by a method of sending information in a predetermined format using electronic mail.

In step S5 of FIG. 2, a database is constructed and disclosed. More specifically, the service provider constructs a database for the number of potential buyers for the merchandize/services of a specific category on the basis of the purchase request merchandize/service information (number of merchandize items) transmitted from the users. A database to be disclosed is customized for each seller. The merchandize/service information is disclosed to a seller within the range of the category of merchandize which the seller deals. A method of disclosing a database is shown in FIG. 5. That is, a seller accesses the service provider, and browses a Web page constructed for each seller. Alternatively, a seller is notified of the database by the service provider via electronic mail.

In step S7 of FIG. 2, merchandize providing information is notified. That is, a seller determines merchandize/service providing conditions, i.e., a price, merchandize specifications, and purchase method on the basis of the revised information of the database, its own stock, and purchasing price. The service provider is notified of the determined merchandize providing information. More specifically, as shown in FIG. 5, the seller prepares merchandize providing information mail including the merchandize specifications, price, purchasing method, and transmission request message and sends it to the service provider. Note that the merchandize providing information may be notified not by sending electronic mail but by inputting the information on the Web page provided by the service provider.

In step S7 of FIG. 2, the merchandise providing information is notified. That is, all the potential buyers for the merchandize/services of the category of interest are notified of the merchandise providing information of the seller from the service provider. The merchandise providing information may be notified by sending electronic mail or writing the information on the Web page prepared for only each potential buyer. Similarly, each potential buyer is notified of merchandise providing information from other sellers. The number of potential buyers in the database for each seller is cleared when the merchandise providing information is notified from each seller. Each seller only presents the merchandise providing information to each potential buyer at this time. The number of potential buyers on the database can always be new information which represent those who have not presented merchandize providing information to new potential buyers.

In step S9 of FIG. 2, a sales agreement is made. That is, as shown in FIG. 3, each user browses the merchandize providing information provided by one or more sellers, checks the sales conditions of the respective sellers, and determines the best seller. The user directly accesses the determined seller via the Web page, electronic mail, telephone, or FAX. A sales agreement is made between the user and seller.

Note that once a sales agreement is made, the buyer notifies the service provider of cancellation of the purchasing will. The service provider deletes the database information concerning this buyer. The remaining sellers who can make no sales agreement with this user can know that a sales agreement has been made with another seller by browsing the database of the service provider.

A method of canceling the purchasing will can be done within a predetermined due date. More specifically, once a user registers purchase request information, the predetermined due date is set, and the service provider instructs sellers to provide merchandise providing information within the predetermined due date. The purchasing will is canceled at the end of the due date. As shown in FIG. 5, each user transmits a clear mail/command to the service provider. The service provider clears the corresponding information (purchase request merchandize/service information) from the database on the basis of the clear mail/command.

The present invention has been described for a specific embodiment under specific conditions. Many changes and modifications may obviously be made within the scope of the invention without departing from the appended claims.

What is claimed is:

1. An electronic bid method characterized in that a buyer registers desired merchandise/service information in a database of a service provider via a network,
the service provider discloses to a seller via the network information including the number of potential buyers for each merchandise/service on the basis of the registered merchandise/service information,
the seller determines a sales condition on the basis of the disclosed information and notifies the service provider of merchandise providing information, and
the service provider notifies the potential buyers of the merchandise providing information notified from the seller.

2. An electronic bid method according to claim 1, characterized in that the service provider comprises a service provider connected to the seller and buyer via the network, and the desired merchandize/service information of the buyer is registered using electronic mail or a Web page provided by the service provider.

3. An electronic bid method according to claim 1, characterized in that the sales condition of which the service provider is notified from the seller includes information of a price, merchandize specifications, and purchasing method.

4. An electronic bid method according to claim 1, characterized in that when merchandize providing information is presented by at least one seller, the buyer checks sales conditions of the merchandize providing information and makes a sales agreement.

5. An electronic bid method according to claim 4, characterized in that
once the sales agreement is made, the buyer notifies the service provider of cancellation of a will of a purchase request, and
the service provider deletes database information concerning the buyer upon reception of the notification.

6. An electronic bid system for allowing a service provider to serve as an agent in a sales transaction between a buyer and a seller via a network, characterized by comprising
purchase merchandise/service information processing means comprised of means for storing merchandise/service information to be purchased by a buyer and means for notifying a seller of the number of potential buyers for each merchandise/service on the basis of the merchandise/service information to be purchased and stored in the storing means, and
sales merchandise/service information processing means comprised of means for notifying the service provider of a sales condition determined by the seller and means for notifying the buyer of the sales condition notified from the seller.

7. An electronic bid system according to claim 6, characterized in that the desired merchandize/service information of the buyer is registered using electronic mail or a Web page provided by the service provider.

8. An electronic bid system according to claim 6, characterized in that the sales condition of which the service provider is notified from the seller includes information of a price, merchandize specifications, and purchasing method.

9. An electronic bid system according to claim 8, characterized in that
once the sales agreement is made, the buyer notifies the service provider of cancellation of a will of a purchase request, and
the service provider deletes database information concerning the buyer upon reception of the notification.
